(19) United States
(12) Patent Application Publication
(10) Pub. No.: US 2020/0227069 A1
(43) Pub. Date: Jul. 16, 2020

(54) METHOD, DEVICE AND APPARATUS FOR RECOGNIZING VOICE SIGNAL, AND STORAGE MEDIUM

(71) Applicant: Baidu Online Network Technology (Beijing) Co., Ltd, Beijing (CN)

(72) Inventors: Yong Liu, Beijing (CN); Ji Zhou, Beijing (CN); Xiangdong Xue, Beijing (CN); Peng Wang, Beijing (CN); Lifeng Zhao, Beijing (CN)

(73) Assignee: Baidu Online Network Technology (Beijing) Co., Ltd., Beijing (CN)

(21) Appl. No.: 16/601,630

(22) Filed: Oct. 15, 2019

(30) Foreign Application Priority Data
Jan. 11, 2019 (CN) 201910026325.X

(51) Int. Cl. G10L 25/51; G10L 17/26; G10L 17/04; G10L 15/06

(52) U.S. Cl. CPC G10L 25/51; G10L 15/063; G10L 17/04; G10L 17/26

(57) ABSTRACT

A method, device and apparatus for recognizing a voice signal, and a storage medium are provided. The method includes: collecting a voice signal; extracting the voiceprint feature of the voice signal; comparing the voiceprint feature with a pre-stored reference voiceprint feature; and recognizing a content of the voice signal with a voice recognition model, in response to a consistence of the voiceprint feature with the pre-stored reference voiceprint feature. Embodiments of the present application can improve the accuracy of recognizing voice signals.

### CROSS-REFERENCE TO RELATED APPLICATION

This application claims priority to Chinese Patent Application No. 201910026325.X, filed on Jan. 11, 2019, which is hereby incorporated by reference in its entirety.

### TECHNICAL FIELD

The present application relates to the field of computer technology, and in particular, to a method, device, apparatus and storage medium for recognizing a voice signal.

### BACKGROUND

Misrecognition may occur in the existing voice interactive device sometimes. For example, when a user does not speak, voice interactive devices may mistakenly take voice signals sent by television, broadcast as voices uttered by the user, and recognize these voice signals. Alternatively, even voice interactive devices recognize a user's voice successfully, the user's voice is not transferred into a correct text due to the background noise and the user's accent. These misrecognized situations affect the user's experience.

### SUMMARY

A method, device and apparatus for recognizing a voice signal, and a storage medium are provided according to embodiments of the present application, so as to at least solve the above technical problems in the existing technology.

In a first aspect, a method for recognizing a voice signal is provided according to embodiments of the present application, and the method includes:

collecting a voice signal;

extracting a voiceprint feature of the voice signal;

comparing the voiceprint feature with a pre-stored reference voiceprint feature; and

recognizing a content of the voice signal with a voice recognition model, in response to a consistence of the voiceprint feature with the pre-stored reference voiceprint feature.

In one implementation, the method further includes: prestoring at least one reference voiceprint feature,

wherein the comparing the voiceprint feature with a pre-stored reference voiceprint feature includes:

comparing the voiceprint feature with the reference voiceprint feature, to determine whether the voiceprint feature is consistent with the reference voiceprint feature.

In one implementation, the method further includes: determining at least one reference voiceprint feature by:

acquiring at least one user's voice signal;

extracting a voiceprint feature of the user's voice signal; and

determining the voiceprint feature of the user's voice signal as the reference voiceprint feature.

In one implementation, the method further includes: pre-establishing at least one voice recognition model corresponding to the at least one reference voiceprint feature,

wherein the recognizing the content of the voice signal with a voice recognition model, includes:

determining a voice recognition model corresponding to the reference voiceprint feature, in response to a consistence of the voiceprint feature with the reference voiceprint feature; and

recognizing the content of the voice signal with the determined voice recognition model.

In one implementation, the pre-establishing at least one voice recognition model corresponding to the at least one reference voiceprint feature includes:

training the voice recognition model corresponding to the reference voiceprint feature, by using a user's voice signal having the reference voiceprint feature and real text information of the user's voice signal,

wherein the training the voice recognition model corresponding to the reference voiceprint feature includes:

inputting the user's voice signal into the voice recognition model;

comparing text information outputted by the voice recognition model with the real text information, to obtain a comparison result; and

adjusting parameters of the voice recognition model according to the comparison result.

In a second aspect, a device for recognizing a voice signal is provided according to embodiments of the present application, and the device includes:

a collecting module configured to collect a voice signal;

an extracting module configured to extract a voiceprint feature of the voice signal;

a comparing module configured to compare the voiceprint feature with a pre-stored reference voiceprint feature; and

a recognizing module configured to recognizing a content of the voice signal with a voice recognition model, in response to a consistence of the voiceprint feature with the pre-stored reference voiceprint feature.

In one implementation, the device further includes: a voice feature storing module configured to prestore at least one reference voice feature,

wherein the comparing module is configured to compare the voiceprint feature with the reference voiceprint feature, to determine whether the voiceprint feature is consistent with the reference voiceprint feature.

In one implementation, the device further includes:

a voiceprint determining module configured to determine at least one reference voiceprint feature by:

acquiring at least one user's voice signal;

extracting a voiceprint feature of the user's voice signal; and

determining the voiceprint feature of the user's voice signal as the reference voiceprint feature.

In one implementation, the device further includes:

a model establishing module configured to pre-establish at least one voice recognition model corresponding to the at least one reference voiceprint feature,

wherein the recognizing module is configured to determine a voice recognition model corresponding to the reference voiceprint feature, in response to a consistence of the voiceprint feature with the reference voiceprint feature; and

recognize the content of the voice signal with the determined voice recognition model.

In one implementation, the model establishing module is configured to:

train the voice recognition model corresponding to the reference voiceprint feature, by using a user's voice signal having the reference voiceprint feature and real text information of the user's voice signal, wherein

the model establishing module is further configured to:

input the user's voice signal into the voice recognition model;

compare text information outputted by the voice recognition model with the real text information, to obtain a comparison result; and

adjust parameters of the voice recognition model according to the comparison result.

In a third aspect, an apparatus for recognizing a voice signal is provided according to embodiments of the present application. The functions of the apparatus may be implemented by hardware or by executing corresponding software with hardware. The hardware or software includes one or more modules corresponding to the functions described above.

In a possible implementation, the apparatus structurally includes a processor and a memory, wherein the memory is configured to store programs which support the device to execute the above method for recognizing a voice signal, and the processor is configured to execute the programs stored in the memory. The apparatus may further include a communication interface through which the apparatus communicates with other devices or communication networks.

In a fourth aspect, a computer-readable storage medium is provided for storing computer software instructions used by the apparatus for recognizing a voice signal, wherein the computer software instructions include programs involved in execution of the above method for recognizing a voice signal.

The above technical solutions have the following advantages or beneficial effects.

In the embodiment of the present application, after collecting the voice signal, it is determined whether the voiceprint feature of the voice signal is consistent with the reference voiceprint feature stored in advance. If they are consistent, the voice recognition model is used to recognize the content of the voice signal. Through this step-by-step detection, the recognition rate of the voice signal can be improved.

The above summary is for the purpose of the specification only and is not intended to be limiting in any way. In addition to the illustrative aspects, embodiments, and features described above, further aspects, embodiments, and features of the present application will be readily understood by reference to the drawings and the following detailed description.

### BRIEF DESCRIPTION OF THE DRAWINGS

In the drawings, unless otherwise specified, identical reference numerals will be used throughout the drawings to refer to identical or similar parts or elements. The drawings are not necessarily drawn to scale. It should be understood that these drawings depict only some embodiments disclosed in accordance with the present application and are not to be considered as limiting the scope of the present application.

FIG. 1 shows a flow chart of a method for recognizing a voice signal according to an embodiment of the present application.

FIG. 2 shows a structural block diagram of a device for recognizing a voice signal according to an embodiment of the present application.

FIG. 3 shows a structural block diagram of a device for recognizing a voice signal according to an embodiment of the present application.

FIG. 4 shows a structural block diagram of an apparatus for recognizing a voice signal according to an embodiment of the present application.

### DETAILED DESCRIPTION OF THE EMBODIMENTS

In the following, only certain exemplary embodiments are briefly described. As those skilled in the art would realize, the described embodiments may be modified in various different ways, all without departing from the spirit or scope of the present application. Accordingly, the drawings and description are to be regarded as illustrative in nature and not restrictive.

A method and device for recognizing a voice signal are provided according to the embodiments of the present application. The technical solution is described through the following embodiments.

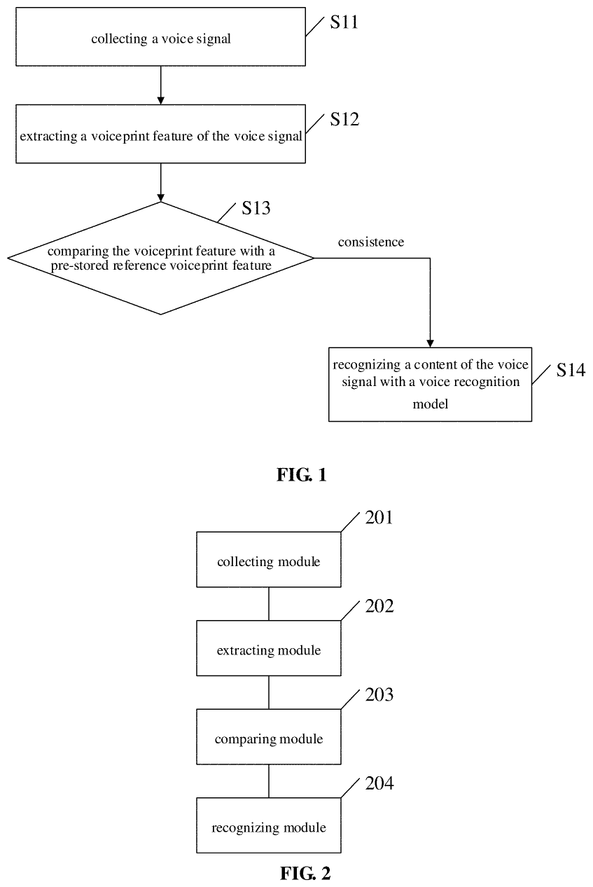

As shown in FIG. 1, the method for recognizing a voice signal includes:

S11: collecting a voice signal;

S12: extracting a voiceprint feature of the voice signal;

S13: comparing the voiceprint feature with a pre-stored reference voiceprint feature; and

S14: recognizing a content of the voice signal with a voice recognition model, in response to a consistence of the voiceprint feature with the pre-stored reference voiceprint feature.

In a possible embodiment, in S11, the collecting a voice signal may include: receiving an audio signal, extracting a voice signal from the audio signal. In particular, the audio signal is a carrier with frequency and amplitude change information of a regular sound wave of a voice, music or sound effect. With the feature of the sound wave, the voice signal can be extracted from the audio signal.

In a possible embodiment, in S12, the voiceprint feature may be extracted in a voice signal using voiceprint recognition technology. Voiceprint is a sound wave spectrum carrying linguistic information, displayed by an electroacoustic instrument. The voiceprint features of any two people are different, and each person's voiceprint feature is relatively stable. Voiceprint recognition can be divided into two types: text-dependent voiceprint recognition and text-independent voiceprint recognition. The text-dependent voiceprint recognition system requires users to pronounce according to the prescribed content, and each person's voiceprint model is accurately established one by one, and the users must also pronounce according to the prescribed content during recognition. The text-independent voiceprint recognition system does not require the user to pronounce in accordance with the prescribed content. In the embodiment of the present application, a text-independent voiceprint recognition method can be adopted. When the voiceprint feature is extracted and compared, a voice signal of any content can be used without requiring users to pronounce according to the specified content.

In a possible embodiment, at least one reference voiceprint feature could be stored in advance. For example, a voice interaction device can have multiple users, which can be regarded as the “owners” of the voice interaction device. In the embodiment of the present application, each user's voiceprint feature can be used as a reference voiceprint feature, and each reference voiceprint feature is stored. Specifically, at least one reference voiceprint feature could be determined by: acquiring at least one user's voice signal; extracting a voiceprint feature of the user's voice signal; and determining the voiceprint feature of the user's voice signal as the reference voiceprint feature. In order to determine the reference voiceprint feature, when the user's voice signals are collected, the recording device can be turned on under the user's knowledge, to record the user's voice signals in various scenes in life.

Accordingly, in a possible embodiment, S13 may include: comparing the voiceprint feature with the reference voiceprint feature, to determine whether the voiceprint feature is consistent with the reference voiceprint feature.

For example, N (N is a positive integer) reference voiceprint features are stored in advance. In the comparison process, the voiceprint feature is sequentially compared with the N reference voiceprint features. When the voiceprint feature is found to be consistent with a certain reference voiceprint feature, the comparison result indicates they are consistent. There is no need to compare the voiceprint feature with the rest reference voiceprint features. If the voiceprint feature is inconsistent with any of the reference voiceprint features, the comparison result indicates they are inconsistent. Alternatively, the voiceprint feature may be compared with the N reference voiceprint features respectively to obtain N comparison results, each comparison result indicating a similarity between the voiceprint feature and the corresponding reference voiceprint feature. The comparison result indicating the maximum similarity is obtained, when the maximum similarity exceeds a preset similarity threshold, it is determined that the voiceprint feature is consistent with the corresponding reference voiceprint feature; when the maximum similarity does not exceed the preset similarity threshold, it is determined that the voiceprint feature is inconsistent with any of the reference voiceprint features.

In a possible embodiment, a voice recognition model corresponding to each of the reference voiceprint features may be established in advance. For example, for the N users of the voice interaction device, the voiceprint features of the N users are respectively extracted in advance as the N reference voiceprint features; and the corresponding voice recognition models are respectively set for the N reference voiceprint features. The correspondence between the users, the reference voiceprint features, and the voice recognition models are as shown in Table 1 below.

TABLE 1

| User | reference voiceprint feature | voice recognition model |
|---|---|---|
| User 1 | reference voiceprint feature 1 | voice recognition model 1 |
| User 2 | reference voiceprint feature 2 | voice recognition model 2 |
| . . . | . . . | . . . |
| User N | reference voiceprint feature N | voice recognition model N |

When the voice recognition model is established, the voice recognition model could be trained by using a voice signal corresponding to the reference voiceprint feature and real text information corresponding to the voice signal. The training process includes: inputting the voice signal into the voice recognition model, comparing the predicted text information outputted by the voice recognition model with the real text information, to obtain a comparison result, and adjusting parameters of the voice recognition model according to the comparison result. By continuously adjusting the parameters, the probability that the predicted text information is consistent with the real text information reaches a preset recognition threshold.

A voice signal and real text information corresponding to the voice signal may be collected in the following manner. For example, the text information is provided to the user, and the text information is read by the user, and the voice signal generated by the user reading the text information is collected, that is, the voice signal and the real text information corresponding to the voice signal can be obtained. In addition, as the number of the collected voice signals of the user increases, the user may be provided with text information that cannot be accurately read by the user according to the user's pronunciation habits. After the user reads the text information, the voice signal uttered by the user is collected, and the voice signal and the corresponding real text information are stored. In the above process, the manner of providing text information to the user may include: displaying text information on the screen, or playing audio information corresponding to the text information, etc.

In a possible embodiment, during the process of using the voice interactive device by the user, the training sample (i.e., the voice signal and the corresponding real text information) may be gradually recorded and added, and the added training sample is used to train the voice recognition model, so that the recognition of the voice recognition model is more accurate.

Accordingly, in S14, the recognizing the content of the voice signal with a voice recognition model may include: determining a voice recognition model corresponding to the reference voiceprint feature, in response to a consistence of the voiceprint feature with the reference voiceprint feature; recognizing the content of the voice signal with the determined voice recognition model.

For example, in one embodiment, the voiceprint feature of the collected voice signal is consistent with the reference voiceprint feature 2 of Table 1. Then, the voice recognition model 2 corresponding to the reference voiceprint feature 2 is acquired, and the voice recognition model 2 is used to identify the content of the voice signal.

In a possible embodiment, the above comparison and recognition process may be executed in the cloud. Alternatively, the reference voiceprint feature and the voice recognition model can be sent to the voice interaction device, and the comparison and recognition process above is performed by the voice interaction device, thereby improving the recognition efficiency.

The method according to embodiments of the present application can be applied to devices with voice interaction functions, including but not limited to smart speaker boxes, smart speaker boxes with screens, televisions with voice interaction functions, smart watches, and in-vehicle intelligent voice devices. In cases of low security requirements, the controllable adjustment of the error rejection rate and the error acceptance rate can be supported, and the error rejection rate of the comparison and recognition above can be appropriately reduced, so as to avoid causing no response to the user's voice signal.

For example, for S13 above, in the initial state, a criterion for determining whether the voiceprint feature is consistent with the reference voiceprint feature is set as follows: if the similarity between the voiceprint feature and the reference voiceprint feature exceeds 90%, it is determined that the two are consistent. In the process of using the voice interactive device, if there is frequent occurrence of no response to the voice signal uttered by the user, the above criterion could be appropriately lowered, for example, the criterion may be adjusted as follows: if the similarity between the voiceprint feature and the reference voiceprint feature exceeds 80%, it is determined that the two are consistent. On the contrary, in the process of using the voice interactive device, if the non-user voice signals are frequently recognized, the above criterion may be appropriately raised, for example, the criterion may be adjusted as follows: if the similarity between the voiceprint feature and the reference voiceprint feature exceeds 95%, it is determined that the two are consistent.

A device for recognizing a voice signal is provided according to an embodiment of the present application. FIG. 2 shows a structural block diagram of a device for recognizing a voice signal according to an embodiment of the present application, which includes:

a collecting module 201 configured to collect a voice signal;

an extracting module 202 configured to extract a voiceprint feature of the voice signal;

a comparing module 203 configured to compare the voiceprint feature with a pre-stored reference voiceprint feature; and

a recognizing module 204 configured to recognizing a content of the voice signal with a voice recognition model, in response to a consistence of the voiceprint feature with the pre-stored reference voiceprint feature.

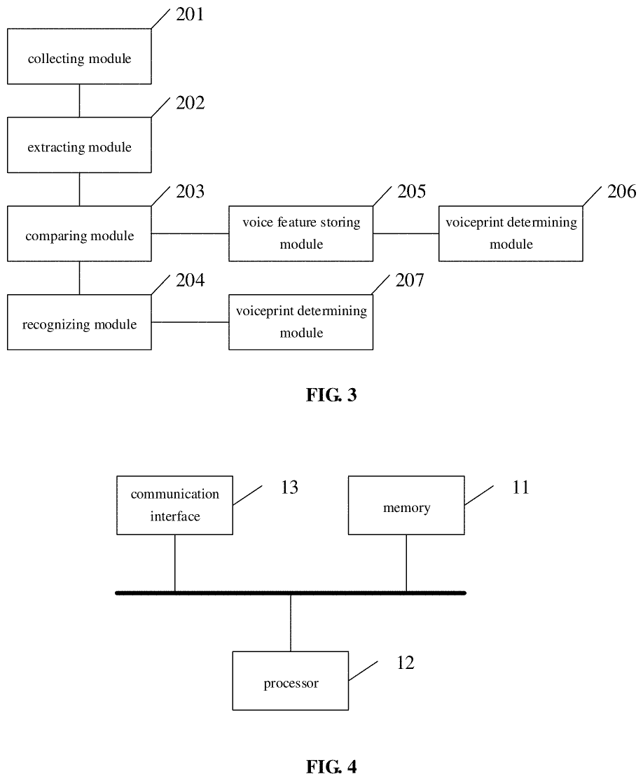

FIG. 3 shows a structural block diagram of a device for recognizing a voice signal according to another embodiment of the present application, which includes: a collecting module 201, a extracting module 202, a comparing module 203 and a recognizing module 204, these four modules above are the same as the corresponding modules in the embodiment above, and are not described again.

The device also includes: a voice feature storing module 205 configured to prestore at least one reference voice feature,

wherein the comparing module 203 is configured to compare the voiceprint feature with the reference voiceprint feature, to determine whether the voiceprint feature is consistent with the reference voiceprint feature.

In a possible embodiment, the device further includes: a voiceprint determining module 206 configured to determine at least one reference voiceprint feature by: acquiring at least one user's voice signal; extracting a voiceprint feature of the user's voice signal; and determining the voiceprint feature of the user's voice signal as the reference voiceprint feature.

In a possible embodiment, the device further includes: a model establishing module 207 configured to pre-establish at least one voice recognition model corresponding to the at least one reference voiceprint feature,

wherein the recognizing module 204 is configured to determine a voice recognition model corresponding to the reference voiceprint feature, in response to a consistence of the voiceprint feature with the reference voiceprint feature; and recognize the content of the voice signal with the determined voice recognition model.

In a possible embodiment, wherein the model establishing module 207 is configured to train the voice recognition model corresponding to the reference voiceprint feature, by using a user's voice signal having the reference voiceprint feature and real text information of the user's voice signal, wherein the model establishing module is further configured to: input the user's voice signal into the voice recognition model; compare text information outputted by the voice recognition model with the real text information, to obtain a comparison result; and adjust parameters of the voice recognition model according to the comparison result.

For the functions of the modules in the devices in the embodiments of the present application, refer to the corresponding description in the foregoing methods, and details are not described herein again.

An apparatus for recognizing a voice signal is provided according to the embodiment of the application. FIG. 4 shows a structural block diagram of an apparatus for recognizing a voice signal according to an embodiment of the present application, which includes: a memory 11 and a processor 12. The memory 11 stores a computer program executable on the processor 12. When the processor 12 executes the computer program, a method for recognizing a voice signal in the foregoing embodiment is implemented. The number of the memory 11 and the processor 12 may be one or more.

The apparatus further includes a communication interface 13 configured to communicate with external devices and exchange data.

The memory 11 may include a high-speed RAM memory and may also include a non-volatile memory, such as at least one magnetic disk memory.

If the memory 11, the processor 12, and the communication interface 13 are implemented independently, the memory 11, the processor 12, and the communication interface 13 may be connected to each other through a bus and communicate with one another. The bus may be an Industry Standard Architecture (ISA) bus, a Peripheral Component Interconnect (PCI) bus, an Extended Industry Standard Component (EISA) bus, or the like. The bus may be divided into an address bus, a data bus, a control bus, and the like. For ease of illustration, only one bold line is shown in FIG. 4, but it does not mean that there is only one bus or one type of bus.

Optionally, in a specific implementation, if the memory 11, the processor 12, and the communication interface 13 are integrated on one chip, the memory 11, the processor 12, and the communication interface 13 may implement mutual communication through an internal interface.

According to an embodiment of the present application, a computer-readable storage medium is provided for storing computer programs. When executed by the processor, the programs implement any of the methods according to above embodiments.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or device (such as a computer-based system, a processor-included system, or other system that fetch instructions from an instruction execution system, device, or device and execute the instructions). For the purposes of this specification, a “computer-readable medium” may be any device that may contain, store, communicate, propagate, or transport the program for use by or in connection with the instruction execution system, device, or device. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

It should be understood that various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A method for recognizing a voice signal, comprising:
collecting a voice signal;
extracting a voiceprint feature of the voice signal;
comparing the voiceprint feature with a pre-stored reference voiceprint feature; and
recognizing a content of the voice signal with a voice recognition model, in response to a consistence of the voiceprint feature with the pre-stored reference voiceprint feature.

2. The method according to claim 1, further comprising: prestoring at least one reference voiceprint feature,
wherein the comparing the voiceprint feature with a pre-stored reference voiceprint feature comprises:
comparing the voiceprint feature with the reference voiceprint feature, to determine whether the voiceprint feature is consistent with the reference voiceprint feature.

3. The method according to claim 2, further comprising: determining at least one reference voiceprint feature by:
acquiring at least one user's voice signal;
extracting a voiceprint feature of the user's voice signal; and
determining the voiceprint feature of the user's voice signal as the reference voiceprint feature.

4. The method according to claim 2, further comprising: pre-establishing at least one voice recognition model corresponding to the at least one reference voiceprint feature,
wherein the recognizing the content of the voice signal with a voice recognition model comprises:
determining a voice recognition model corresponding to the reference voiceprint feature, in response to a consistence of the voiceprint feature with the reference voiceprint feature; and
recognizing the content of the voice signal with the determined voice recognition model.

5. The method according to claim 4, wherein the pre-establishing at least one voice recognition model corresponding to the at least one reference voiceprint feature comprises:
training the voice recognition model corresponding to the reference voiceprint feature, by using a user's voice signal having the reference voiceprint feature and real text information of the user's voice signal,
wherein the training the voice recognition model corresponding to the reference voiceprint feature comprises:
inputting the user's voice signal into the voice recognition model;
comparing text information outputted by the voice recognition model with the real text information, to obtain a comparison result; and
adjusting parameters of the voice recognition model according to the comparison result.

6. An apparatus for recognizing a voice signal, comprising:
one or more processors; and
a storage device configured to store one or more programs, wherein
the one or more programs, when executed by the one or more processors, cause the one or more processors to:
collect a voice signal;
extract a voiceprint feature of the voice signal;
compare the voiceprint feature with a pre-stored reference voiceprint feature; and
recognize a content of the voice signal with a voice recognition model, in response to a consistence of the voiceprint feature with the pre-stored reference voiceprint feature.

7. The apparatus according to claim 6, wherein the one or more programs, when executed by the one or more processors, cause the one or more processors further to:
prestore at least one reference voiceprint feature, and
wherein the one or more programs, when executed by the one or more processors, cause the one or more processors further to:
compare the voiceprint feature with the reference voiceprint feature, to determine whether the voiceprint feature is consistent with the reference voiceprint feature.

8. The apparatus according to claim 7, wherein the one or more programs, when executed by the one or more processors, cause the one or more processors further to:
determine at least one reference voiceprint feature by:
acquiring at least one user's voice signal;
extracting a voiceprint feature of the user's voice signal; and
determining the voiceprint feature of the user's voice signal as the reference voiceprint feature.

9. The apparatus according to claim 7, wherein the one or more programs, when executed by the one or more processors, cause the one or more processors further to:
pre-establish at least one voice recognition model corresponding to the at least one reference voiceprint feature, and
wherein the one or more programs, when executed by the one or more processors, cause the one or more processors further to:
determine a voice recognition model corresponding to the reference voiceprint feature, in response to a consistence of the voiceprint feature with the reference voiceprint feature; and
recognize the content of the voice signal with the determined voice recognition model.

10. The apparatus according to claim 9, wherein the one or more programs, when executed by the one or more processors, cause the one or more processors further to:
train the voice recognition model corresponding to the reference voiceprint feature, by using a user's voice signal having the reference voiceprint feature and real text information of the user's voice signal, and
wherein the one or more programs, when executed by the one or more processors, cause the one or more processors further to:
input the user's voice signal into the voice recognition model;
compare text information outputted by the voice recognition model with the real text information, to obtain a comparison result; and
adjust parameters of the voice recognition model according to the comparison result.

11. A non-transitory computer-readable storage medium comprising computer executable instructions stored thereon, wherein the executable instructions, when executed by a processor, causes the processor to implement the method of claim 1.
